(19) United States
(12) Patent Application Publication
(10) Pub. No.: US 2026/0326460 A1
(43) Pub. Date: Oct. 22, 2026

(54) Printer and Method for Printing with Improved Registration Alignment

(71) Applicant: Zebra Technologies Corporation, Lincolnshire, IL (US)

(72) Inventors: Guihong Zhou, Guangzhou (CN); Zhong Gui Wang, Guangzhou (CN); Huanhua Liao, Guangzhou (CN); Yong Liu, Guangzhou (CN); Yue Huang, Guangzhou (CN)

(73) Assignee: Zebra Technologies Corporation, Lincolnshire, IL (US)

(21) Appl. No.: 19/182,514

(22) Filed: Apr. 17, 2025

(51) Int. Cl. B41J 11/20; B41J 2/325; B41J 3/407; B41J 11/00; B41J 11/04; B41J 35/04

(52) U.S. Cl. CPC B41J 11/20; B41J 3/4075; B41J 11/0095; B41J 11/04; B41J 35/04; B41J 2/325

(57) ABSTRACT

An example printer includes: a printhead supported in a carriage; a platen roller configured to feed a media supply through a nip defined between the platen roller and the printhead; a media guide plate disposed between the media supply and the platen roller, the media guide plate configured to guide the media supply towards the nip; a sensor assembly supported in at least one of the media guide plate or the carriage, the sensor assembly configured to obtain sensor data representing the media supply; and a controller configured to: obtain print data for printing on one media segment of the media segments; obtain sensor data from the sensor assembly to identify a feature associated with the one media segment; and align, based on the identified feature, the media segment with the printhead for printing the print data on the one media segment.

### BACKGROUND

Printers may be configured to print onto a media supply formed from discrete media segments, such as labels. If the registration alignment of the media supply is inaccurate, the print operation may be misaligned with a printable region of the discrete media segments, or misaligned with the media segments altogether.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a printer with improved registration alignment.

FIG. 2 is a block diagram of certain internal components of the printer of FIG. 1.

FIG. 3A is a diagram of an example sensor assembly and media guide plate for a printer with improved registration alignment.

FIG. 3B is a block diagram of the printer of FIG. 1 with the sensor assembly and media guide plate of FIG. 3A.

FIG. 4A is a diagram of another example sensor assembly and media guide plate for a printer with improved registration alignment.

FIG. 4B is a block diagram of the printer of FIG. 1 with the sensor assembly and media guide plate of FIG. 4A.

FIG. 5A is a block diagram of the printer of FIG. 1 with another example sensor assembly.

FIGS. 5B and 5C are schematic diagrams of the operation of the sensor assembly of FIG. 5A.

FIG. 6 is a flowchart of an example method of printing with improved registration alignment.

FIGS. 7A and 7B are example graphs of sensor data for improved registration alignment.

FIGS. 8A, 8B, and 8C are schematic diagrams of the movement of a media supply for improved registration alignment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a printer comprising: a printhead supported in a carriage and configured to print onto the media segments; a platen roller configured to feed the media supply through a nip defined between the platen roller and the printhead for print operations; a media guide plate disposed between the media supply and the platen roller, the media guide plate configured to guide the media supply towards the nip; a sensor assembly supported in at least one of the media guide plate or the carriage, the sensor assembly configured to obtain sensor data representing the media supply; and a controller configured to: obtain print data for printing on one media segment of the media segments; obtain sensor data from the sensor assembly to identify a feature associated with the one media segment; and align, based on the identified feature, the media segment with the printhead for printing the print data on the one media segment.

Additional examples disclosed herein are directed to a method comprising: obtaining print data for printing on a media segment of a plurality of media segments forming a media supply; obtaining sensor data from a sensor assembly supported in at least one of a media guide plate and a carriage of a printhead of the printer; identifying, using the sensor data, a feature of the media segment; aligning, based on the identified feature, the media segment with the printhead; and printing the print data onto the media segment.

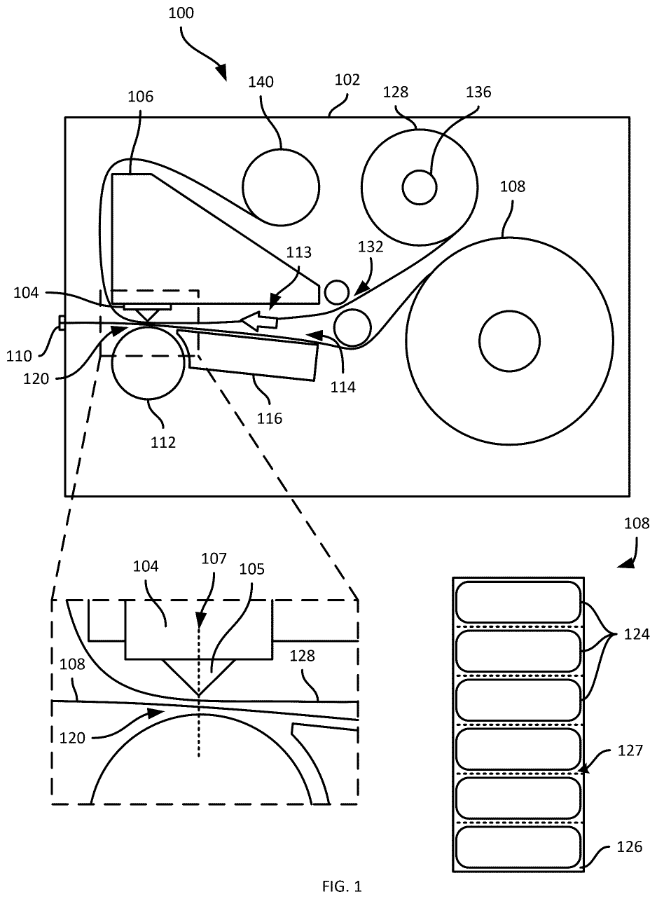

FIG. 1 depicts an example printer 100 for printing with improved registration alignment in accordance with the teachings of this disclosure. The printer 100 includes a housing 102 and a printhead 104 supported in a carriage 106 in the housing 102 and configured to print indicia or other matter onto a media supply 108.

The printer 100 further includes a platen roller 112 configured to feed the media supply 108 (also referred to herein simply as the media 108) past the printhead 104 in a feed direction (denoted by arrow 113) along a media path 114 to allow the heating elements 105 of the printhead 104 to print the matter onto the media 108 at the print line. The platen roller 112 may be driven (e.g., by a motor or the like) to pull the media 108 in the feed direction or in a direction opposite the feed direction (e.g., to retract the media 108) along the media path 114 which may be defined by surfaces, rollers, tensioning members, and the like, including a media guide plate 116. The media guide plate 116 can define a surface that supports the media 108 and can have a length measured parallel the media path from a proximal end disposed near the platen roller 112 and the printhead 104 and a distal end disposed away from the platen roller 112 and the printhead 104 and can have a width that transverses the media path 114 in a direction that is perpendicular to feed direction. The platen roller 112 pulls the media 108 through a nip 120 formed by the printhead 104 and the platen roller 112 where the printhead 104 is configured to print indicia or other matter onto the media 108 via the heating elements. The processed media 108 with the printed indicia may then be dispensed at an outlet 110 of the printer 100.

The printhead 104 includes a linear array of heating elements 105 defining a print line 107 (as referred to as a burn line). The linear array can extend transversely across the media path in a direction that is perpendicular to the feed direction. For thermal transfer printers, the heating elements can be individually activated to apply heat to a ribbon 128 to transfer of pigment from the ribbon 128 to the media 108 to form indicia on the media 108. The ribbon 128 can follow a ribbon path 132 from a ribbon supply spindle 136 to a ribbon take-up spindle 140, where the ribbon path 132 and the ribbon 128 converges with the media path 114 and the media 108 at the print line 107, e.g., due to the nip 120 and diverges away from the media path 114 and the media 108 on both sides of the print line 107. Thus, for thermal transfer printing applications, both the media 108 and the ribbon 128 pass through the nip 120. For direct thermal printers, the printer 100 can be devoid of the ribbon 128 and the heating elements 105 can be individually activated to apply heat to corresponding portions of the media 108 to form indicia on the print media 108. To print indicia onto the media 108, each dot may be activated in accordance with a set of print parameters, such as an activation state, a burn time, and the like.

The media supply 108 may be formed from a plurality of discrete media segments 124, such as labels, wristbands, or the like, which may be connected to each other and/or supported by a liner 126 to form the media supply 108 and organized as a continuous web of serialized media stored as a roll, a fan-folded pile, or the like. In one example, the media segments 124 may be discrete and separable from one another, and the media supply 108 may include tear lines or perforations between each of the media segments 124 to facilitate the separation of each media segment 124. Additionally, or in the alternative, the media can be discrete units spaced along a liner such that gaps 127 exist between adjacent media segments 124 (e.g., between adjacent labels).

Print operations may therefore be to print indicia on a given one of the discrete media segments 124. As such, the media supply 108 is arranged on the media path so that a printable surface of the media segments 124 face the printhead 104 as the media supply is advanced passed the printhead 104 and a backside of the liner 126 supporting the media segments faces and contacts the platen roller 112. Since the media segments 124 are configured to be separable and/or are separated by a gap 127, it is important that the printer 100 detect the media segments 124 to enable printing of the appropriate matter on each media segment 124, and in particular, in a printable region of the media segment 124. Accordingly, the accuracy of the registration or alignment of the media supply 108, and more particularly, a given media segment 124 associated with an ongoing print operation, impact the accuracy of the subsequent print job, and the alignment of the printed media on the given media segment 124. To manage the alignment and registration of the media supply 108, printers 100 may include a gap sensor configured to detect gaps between each of the media segments 124. Typical gap sensors are optical sensors that include an optical source and receiver spaced on either side of the media path to detect changes in the optical signal to identify the discrete media segments 124 and/or the gaps between the discrete media segments 124. However, since the gap sensors and the carriage 106 may each be large and bulky, the gap sensors are typically disposed away from the print line 107, upstream of the media guide 116, and between the media guide plate 116 and a holding region (e.g., a region within a housing of the printer, a designated chamber, or the like) for containing the media supply 108. Additionally, for embodiments of the printer 100 that are configured as a thermal transfer printer, the ribbon path 132 and the ribbon 128 can also prevent such gap sensors from being position proximate to the print line 107, where the ribbon 128 and the media supply 108 would both be in the space between the optical source and the receiver of the gap sensor and the ribbon would interfere with the ability of light to detect the gaps 127. Reflective optical gap sensors, where the optical source and the receiver of the sensor are disposed on the same side of the media supply 108 are typically disposed to sense the label facing surface of the media supply 108 (e.g., above the media path and media supply 108 in the orientation shown in FIG. 1). The ability of such reflective optical sensors to accurately sense the gaps 127 between the media segments 124 when disposed facing the back side of the liner (e.g., under the media path and media supply 108 in the orientation shown in FIG. 1) can be diminished. To account for the foregoing challenges, the optical gap sensor is typically disposed distally (away) from the print line 107 of the printhead 104 (e.g., to the right of the media guide 116 in the orientation shown in FIG. 1), and hence the printer 100 may produce inaccuracies in registration alignment due to the distance that the discrete media segment 124 traverses between the gap sensor and the print line 107 of the printhead 104. For example, in printers processing small labels (e.g., labels having dimensions of about 6 mm or less in length), the distance between the gap sensor and the printhead 104 may be upwards of 100 mm (i.e., over 15 times the length of the discrete media segments or labels). Accordingly, the alignment registration of the labels may be sufficiently inaccurate so as to cause print errors.

In accordance with the present disclosure, the printer 100 employs a sensor assembly disposed and/or supported in at least one of the media guide plate 116 or the carriage 106. That is, the sensor assembly may be integrated with the media guide plate 116 and/or the carriage 106 to allow the sensor assembly and/or a sensing area of the sensor assembly to be located proximate to the print line 107 of the printhead 104. In particular, integration of the sensor assembly into at least one of the media guide plate 116 and the carriage 106 may allow the distance between the sensor assembly and/or sensing area and the nip 120 and/or printhead 104 to be reduced by 80% to 100%, resulting in increased accuracy of registration alignment of the printhead 104 and the media supply 108, and in particular, discrete media segments 124.

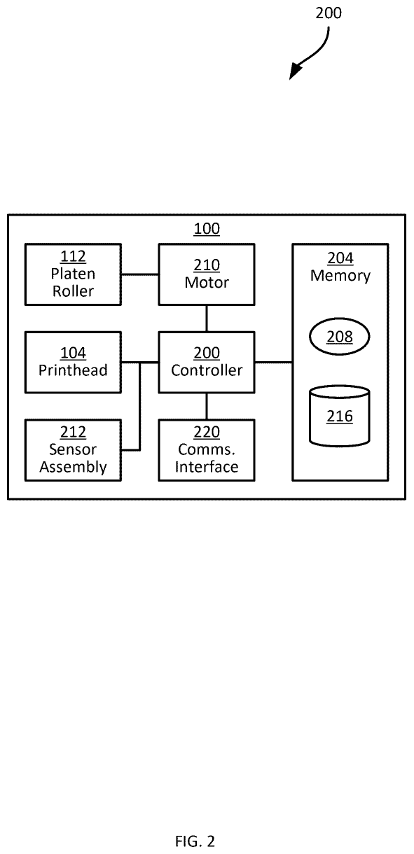

Turning now to FIG. 2, a block diagram of certain internal components of the printer 100 is depicted. The printer 100 includes a controller 200 such as a central processing unit (CPU), graphics processing unit (GPU), microcontroller, series of cooperating processors, application-specific integrated circuit (ASIC), or the like, interconnected with a non-transitory computer-readable storage medium, such as a memory 204. The memory 204 includes a combination of volatile memory (e.g., random access memory or RAM) and non-volatile memory (e.g., read only memory or ROM, electrically erasable programmable read only memory or EEPROM, flash memory). The controller 200 and the memory 204 may each comprise one or more integrated circuits.

The memory 204 stores computer-readable instructions for execution by the controller 200, including one or more applications which, when executed, configure the controller 200 to perform the various functions of the printer 100. In particular, the memory 204 stores an application 208 which, when executed by the controller 200, configures the controller 200 to perform various functions discussed below in greater detail and related to the registration alignment operation of the printer 100. Some or all of the application 208 may also be implemented as a suite of distinct applications.

In particular, the application 208 may configure the controller 200 to obtain print data for printing on one media segment 124 of the media supply 108. The controller 200 may additionally obtain sensor data from a sensor assembly 212 to identify a feature of the one media segment, and control, based on the identified feature, a motor 210 operatively coupled to the platen roller 112 (e.g., via a drive train) to drive the platen roller 112 to align the one media segment 124 with the printhead for printing the print data on the one media segment 124. For example, the controller 200 may analyze the sensor data to detect a front edge (also referred to as a leading edge) and/or a rear edge (also referred to as a trailing edge) of the one media segment 124 and may control the motor 210 to drive the platen roller 112 to move the media segment 124 as appropriate until the identified front edge is aligned with the printhead 104 (e.g., the print line 107 of the printhead 104). When the front edge of the one media segment is aligned with the printhead 104 (e.g., the print line 107 of the printhead 104), the controller 200 may control the printhead 104 to commence the print operation to print the print data on the one media segment 124.

Those skilled in the art will appreciate that the functionality implemented by the controller 200 may also be implemented by one or more specially designed hardware and firmware components, such as a field-programmable gate array (FPGAs), application-specific integrated circuits (ASICs) and the like in other embodiments. In an embodiment, the controller 200 may be, respectively, a special purpose processor which may be implemented via dedicated logic circuitry of an ASIC, an FPGA, or the like in order to enhance the processing speed of the operations discussed herein.

The memory 204 also includes a repository 216 storing rules and data for the registration alignment operation of the printer 100. For example, the repository 216 may store a predetermined distance between the sensor assembly 212 (and/or the sensing area) and the printhead 104 (e.g., the print line 107 of the printhead 104) according to the construction of the printer 100 for use in computing a rotation required by the motor 210 to rotate the platen roller 112 to move the media supply to align the front edge of a media segment 124 with the printhead 104 based on a feature (e.g., a front edge of the media segment 124) identified by the sensor assembly 212. As an example, where the sensor assembly 212 senses the front edge of a media segment 124 and the front edge of the media segment 124 is to be aligned with the print line 107 of the printhead 104, the controller 200 can control the motor 210 to rotate the platen roller 112 to move the media supply 108 in the feed direction 113 by the predetermined distance. As another example, where the sensor assembly 212 senses the rear edge of a media segment 124 and the front edge of the media segment 124 is to be aligned with the print line 107 of the printhead 104, the controller 200 can control the motor 210 to rotate the platen roller 112 to move the media supply 108 in the feed direction 113 by the difference between predetermined distance and the length of the media segment 124 (e.g., measured between the rear and front edges), where the length of the label can also be stored in the repository 216. The repository 216 may further store threshold sensor data signals, for example to differentiate between different features of the media segments 124. In some examples, the threshold sensor data signals may be associated with different media types (e.g., different types and/or sizes of labels, wristbands, other discrete media or the like).

The printer 100 further includes a communications interface 220 enabling the printer to exchange data with other computing devices. The communications interface 220 is interconnected with the controller 200 and includes suitable hardware (e.g., transmitters, receivers, network interface controllers, ports, circuitry and the like) allowing the printer 100 to communicate with other computing devices. The specific components of the communications interface 220 are selected based on the types of links that the printer 100 is to communicate over. For example, the printer 100 may be enabled for wireless communications (e.g., via short-range wireless communications, wireless local or wide area network connections, or the like), wired communications, combinations of wired and wireless communications, and the like.

The printer 100 may further include one or more input and/or output devices (not shown), such as buttons, keypads, touch-sensitive display screens, speakers, and the like, for allowing a user to interface with the printer 100.

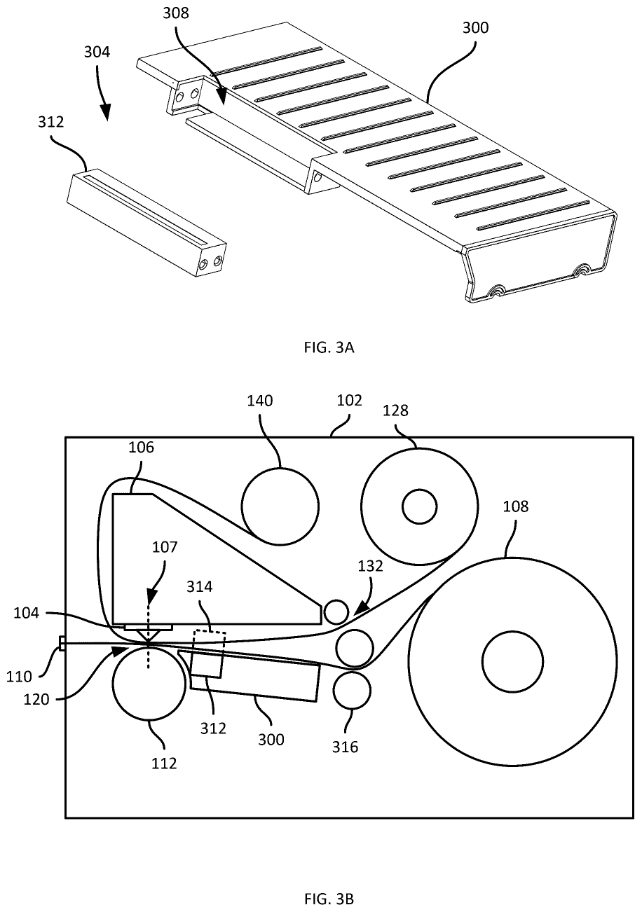

Referring to FIG. 3A, an example media guide plate 300 is depicted. The media guide plate 300 is configured to be implemented in accordance with the present disclosure, for example in the printer 100 or another suitable printer, to support at least a portion of a sensor assembly 304 proximate the platen roller 112. In particular, the media guide plate 300 includes a recess 308 configured to support a sensor assembly 304 comprising a contact image sensor (CIS) 312. The recess 308 is formed at an end of the media guide plate 300 configured to be disposed proximate the platen roller 112 when the media guide plate 300 is installed in the printer 100. Referring to FIG. 3B, a schematic cross-sectional view of the printer 100 with the media guide plate 300 supporting the CIS 312 in the recess 308 proximate the platen roller 112 is depicted.

In particular, the media guide plate 300 may be formed having the recess 308 shaped and sized complementary to the selected CIS 312 to allow the CIS 312 and a sensing area 314 of the CIS 312 to be disposed proximate the platen roller 112 and accordingly, to be disposed proximate to the printhead 104 and the nip 120. In the present example, the CIS 312 can be disposed under the media path and can be oriented so that the length of the CIS 312 extends along the media path generally in the feed direction (e.g., right to left in the orientation shown in FIG. 3B. In the present example, the distance between the CIS 312 and/or the sensing area 314 and the nip 120 or print line 107 may be any distance between about 5 mm to 25 mm or about 10 mm to 20 mm. As an example, the distance between the CIS 312 and the nip 120 or print line 107 is 17 mm. In one example, the distance between the CIS 312 and the nip 120 or print line 107 may be equal to one to three times the radius of the platen roller.

In operation, in response to a print operation, the controller 200 may control the CIS 312 to capture image data in the sensing area 314 that represents the media supply 108. The controller 200 may apply image analysis to the captured image data to recognize distinctive features of the discrete media segments 124 which may be used to facilitate alignment, such as gaps between labels (or rear and/or front edges of adjacent media segments defining the gap, for example by differences in color and/or saturation of the media supply 108, perforations between the media segments 124, or the like. In particular, the controller 200 may apply the image analysis to detect a front edge of a printable region of the media segment 124 or a boundary between the gap and the front edge of the printable region of the media segment. Some non-limiting examples of image analysis algorithms that may be used for the image analysis can include, but are not limited to Stitching/Registration, Filtering, Thresholding, Pixel counting, Segmentation, Inpainting, Edge detection, Color Analysis, Blob discovery & manipulation, Neural net processing, Pattern recognition, Optical character recognition, blurring, normalized lighting, greyscaling, OTSU, thresholding, erosion/dilation, convert correct hull, contour detection, blob/mass calculation normalization, and/or Gauging/Metrology.

After the feature(s) are identified, the controller 200 may then control the platen roller 112 to advance the media supply 108 to align the front edge of the media segment 124 with the printhead 104 (e.g., the print line 107 of the printhead 104). In some examples, a margin can be specified for the media segments 124 (e.g., to avoid printing to close a front or rear edge of the media segments). In such examples, the media supply 108 can be aligned with the media segment 124 based on the margin(s) (e.g., may advance the media segment 124 relative to the print line such by a distance that includes or accounts for the margin(s).

In some examples, after a prior print operation, the media supply 108 may be advanced to output the printed media segment(s) 124 from the housing of the printer 100 where the printed media segments 124 can be separated from the media supply 108 (e.g., by a user, a peeler, a cutter, etc.). In particular, the printed media segment 124 may be output past the nip 120. In some instances, one or more media segments 124 upstream of the printed media segment may also be advanced past the nip 120 without the printhead printing on those media segments (non-printed media segments) due to a distance from the nip 120 to the printer outlet 110. As an example, when the media segments have a length (e.g., measured in the feed direction 113) that is less than the distance between the nip 120 and the outlet 110, one or more non-printed media segments upstream from the printed media segment 124 may be advanced past the nip 120 to allow the printed media segment 124 to reach the outlet 110. Accordingly, on a subsequent print operation, the media supply 108 may be reversed by the nip 120 (e.g., via control of the platen roller 112) to allow for registration and printing on the foremost, next media segment 124 in the media supply 108 after the printed media segment is output from the printer 100. As an example, the media supply 108 can be reversed until the front edge of the foremost, next media segment 124 to be printed is detected by the CIS 312, after which, the media supply 108 can again be advanced in the feed direction 113 to align the foremost, next media segment with the print line 107 of the printhead to allow the printhead 104 to print on the foremost next media segment 124.

In some examples, to further improve registration alignment accuracy, the printer 100 may further include a pinch roller 316 configured to reverse the media supply 108. The pinch roller 316 can be positioned along the media path upstream of the nip 120. In some instances, when a printed media segment 124 is removed from the printer 100 by separating the printed media segment 124 from the media supply 108, the media supply 108 is reversed for registration of the foremost, next media segment 124 in the media supply 108. The media supply 108 can be reversed such that when a front edge of the foremost, next media segment 124 is detectable by the CIS 312, the media supply 108 may no longer be captured or may be inadequately captured by the nip 120 such that the platen roller 112 cannot reliably operate to advance the media supply in the feed direction. In such instances, to allow the CIS 312 to detect the foremost media segment 124 in the media supply 108 and allow the media supply 108 to be advanced through the nip 120 and past the printhead, the pinch roller 316 can operate to advance the media supply 108 at least until the platen roller 112 is capable of advancing the media supply 108 again.

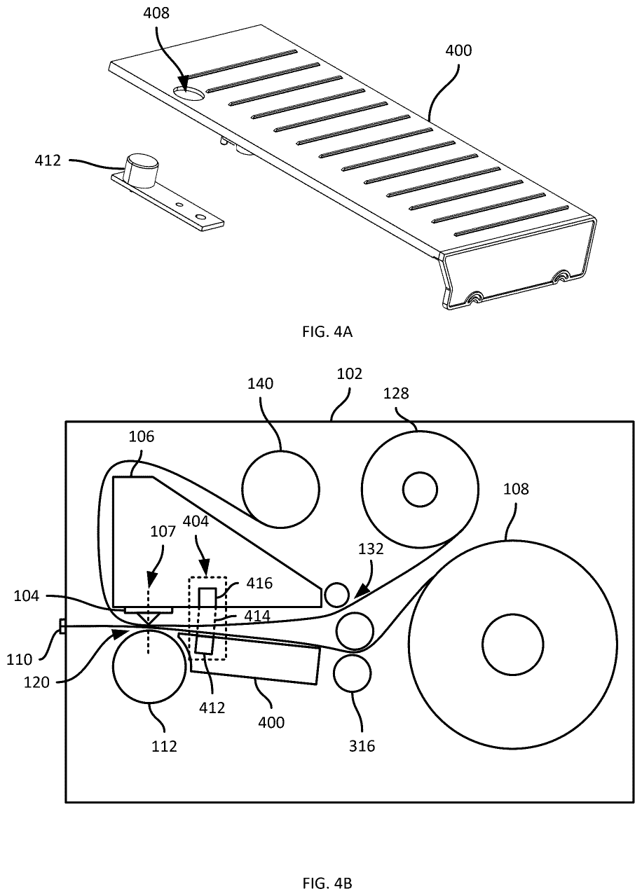

Turning to FIG. 4A, another example media guide plate 400 is depicted. The media guide plate 400 is configured to be implemented in accordance with the present disclosure, for example in the printer 100 or another suitable printer, to support at least a portion of a sensor assembly 404 (FIG. 4B) and/or a sensing area 414 proximate the platen roller 112. In particular, the media guide plate 400 includes an aperture 408 configured to support an ultrasonic emitter 412 of the sensor assembly 404. The aperture 408 is formed at an end of the media guide plate 400 configured to be disposed proximate the platen roller 112 when the media guide plate 400 is installed in the printer 100. Referring to FIG. 4B, the sensor assembly 404 additionally includes a corresponding ultrasonic receiver 416 supported in the carriage 106 opposite the ultrasonic emitter 412. While the ultrasonic emitter 412 is illustrated as being in the media guide 400 and the ultrasonic receiver 416 is illustrated as being in the carriage 106, in exemplary embodiments, the ultrasonic emitter 412 can be disposed in the carriage 106 and the ultrasonic receiver 416 can be disposed in the media guide 400.

The media guide plate 400 may be formed having the aperture 408 shaped and sized complementary to the selected ultrasonic emitter 412 to allow the ultrasonic emitter 412 to be disposed proximate the platen roller 112 and accordingly, to be disposed proximate to the printhead 104 and the nip 120. Further, the carriage 106 may be configured with a recess or aperture to support the ultrasonic receiver 416. The carriage 106 and the media guide plate 400 may be configured to allow the ultrasonic emitter 412 and the ultrasonic receiver 416 to be substantially opposite one another when the carriage 106 and the media guide plate 400 are installed in the printer 100. In the present example, the distance between the ultrasonic emitter 412 and/or the ultrasonic receiver 416 and the nip 120 or print line 107 or between the sensing area 414 and the nip 120 or print line 107 may be any distance between about 5 mm to 25 mm or about 10 mm to 20 mm. As an example, the distance between the ultrasonic emitter 412 and/or the ultrasonic receiver 416 and the nip 120 or print line 107 or between the sensing area 414 and the nip 120 or print line 107 is 19 mm. In one example, the distance between the ultrasonic emitter 412 and/or the ultrasonic receiver 416 and the nip 120 or print line 107 or between the sensing area 414 and the nip 120 or print line 107 may be equal to one to three times the radius of the platen roller.

In operation, in response to a print operation, the controller 200 may control the ultrasonic emitter 412 to emit ultrasonic signals, and may obtain the received ultrasonic signals from the ultrasonic receiver 416. Since the ultrasonic emitter 412 and receiver 416 are disposed on opposing sides of the media path, the media supply 108 is configured to be fed therebetween. In some examples, for thermal transfer printing embodiments, the ribbon 128 can also be fed between the ultrasonic emitter 412 and receiver 416. The strength of the ultrasonic signal detected by the receiver 416 may therefore vary according to the thickness and/or other material parameters of the media supply 108 and the ribbon 128. Since the ribbon 128 is generally a uniform thickness (within manufacturing tolerances), changes in the ultrasonic signal can generally indicate changes in the thickness of the media supply 108 (e.g., based on the presence or absence of media segments 124). Accordingly, the controller 200 may analyze the ultrasonic data obtained from the ultrasonic receiver 416 to recognize steps and/or other changes in the strength of the ultrasonic signal, which may represent features such as gaps between the media segments 124, front edges of the media segments 124, rear edges of the media segments 124, perforations and/or other variances in thickness applied to the distinct media segments 124 to facilitate detection of the boundary between the media segments 124. In some examples, the ultrasonic signals strengths may be compared against predetermined threshold signal strengths (e.g., as stored in the memory 204 from factory testing or the like).

In particular, the controller 200 may apply the analysis to the ultrasonic signals and/or data to detect a front edge of a printable region of the media segment 124. The controller 200 may then control the platen roller 112 to advance the media supply 108 to align the front edge of the media segment 124 with the printhead 104.

To further improve registration alignment accuracy and/or facilitate operation of the printer 100 when the length of the media segments 124 are less than the distance between the nip 120 and the outlet 110, the printer 100 may further include the pinch roller 316 as described herein. As an example, when a printed media segment 124 is removed from the printer 100, the media supply 108 can be reversed for registration of the foremost, next media segment 124 in the media supply 108. The media supply 108 can be reversed such that when a front edge of the foremost, next media segment 124 is detectable by the sensor assembly 404, or in the sensing area 414, the media supply 108 may no longer be captured by the nip 120 such that the platen roller 112 cannot reliably operate to advance the media supply 108 in the feed direction 113. In such instances, to allow the sensor assembly 404 to detect the foremost media segment 124 in the media supply 108 and allow the media supply 108 to be advanced through the nip 120 and past the printhead, the pinch roller 316 can operate to advance the media supply 108 at least until the platen roller 112 is capable of advancing the media supply 108 again.

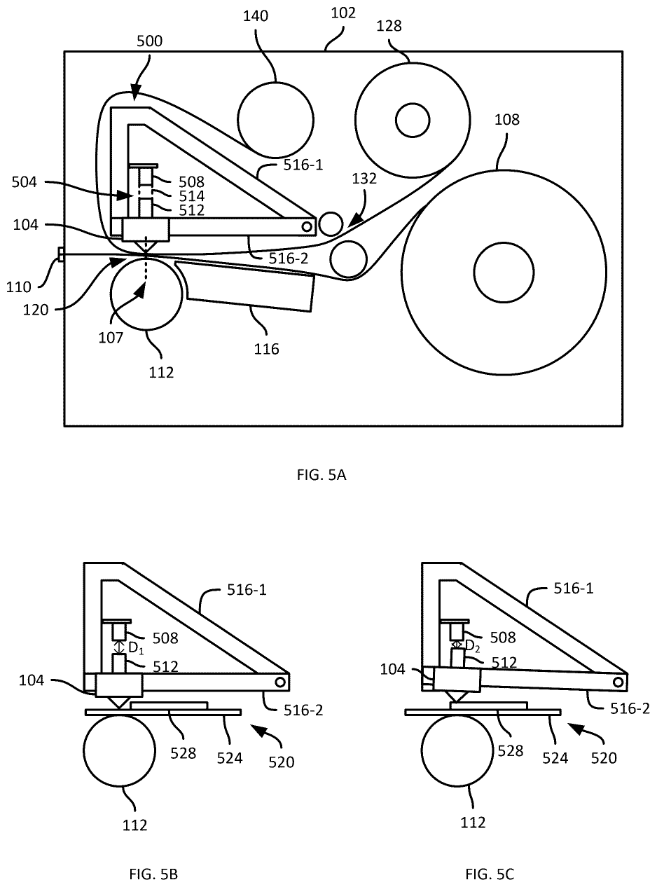

Turning to FIG. 5A, a cross-sectional view of an embodiment of the printer 100 is depicted, including a carriage 500 configured to support the printhead 104 and a sensor assembly 504. The sensor assembly 504 includes a Hall sensor 508 and a magnet 512 and defines a sensing area 514 between the Hall sensor 508 and the magnet 512. The Hall sensor 508, magnet 512, and/or sensing area 514 between the Hall sensor 508 and the magnet 512 can be aligned with the print line 107. In particular, the carriage 500 includes a fixed portion 516-1 configured to stay substantially fixed relative to the housing 102 and other fixed components of the printer 100, such as the platen roller 112, the media guide plate 116, and the like, during operation of the printer 100. The carriage 500 also includes a moveable portion 516-2 configured to support the printhead 104 to be at least partially moveable towards and away from the platen roller 112, for example to accommodate different thicknesses of the media supply 108 (e.g., when the media segments are present or absent between the print line and the platen roller). In other examples, the Hall sensor 508 and the magnet 512 may not be aligned with the print line 107, and may simply be affected (i.e., to move the Hall sensor 508 and the magnet 512 towards and/or away from each other) based on different thicknesses of material in the nip 120 at the print line 107.

In particular, the Hall sensor 508 may be supported in the fixed portion 516-1 of the carriage 500, while the magnet 512 may be supported in the moveable portion 516-2 of the carriage 500 or vice versa. In particular, the Hall sensor 508 is configured to detect a magnetic flux signal and/or changes in the magnetic field of the magnet 512. When the printhead 104 moves towards and away from the platen roller 112, then the a distance between the magnet 512 and the Hall sensor 508 decreases, and hence the magnetic field detected by the Hall sensor 508 is changed.

For example, referring to FIGS. 5B and 5C, a close up view of the nip 120 as a media supply 520 passes through the nip 120. In particular, the media supply 520 includes a liner 524 and a label 528 (e.g., a media segment) supported on the liner 524. When the media supply 520 is positioned in the nip 120 such that only the liner 524 is positioned between the printhead 104 and the platen roller 112, then there is a distance of Di between the magnet 512 and the Hall sensor 508, as depicted in FIG. 5B. As the platen roller 112 drives the media supply 520 through the nip 120, the label 528 enters the nip 120, as depicted in FIG. 5C, such that the liner 524 and label 528 are positioned between the printhead 104 and the platen roller 112. Since the label 528 also has a thickness, the printhead 104 is pushed away from the platen roller 112 by a distance that corresponds to the thicknesses of the liner 524 and the label 528. In particular, the moveable portion 516-2 of the carriage 500 may move (e.g., via rotation or other suitable movements) relative to the fixed portion 516-1, causing the magnet 512 and the Hall sensor 508 to be moved closer to each other, separated by a distance of D2. Since D1 and D2 are different, the Hall sensor 508 will detect a different magnetic field of the magnet 512 at each of the distances.

Accordingly, the sensor assembly 504 may detect changes in the magnetic field, which may represent changes in thickness of the media supply 520. Such changes in thickness may be defined, for example at the edge of a media segment (e.g., media segments 124, label 528) supported on a liner (as in the example of FIGS. 5B and 5C), and/or other variances in thickness applied to the distinct media segments to facilitate detection of the boundary between media segments 124. In some examples, the magnetic field as detected by the Hall sensor 508 may be compared to a predefined magnetic field strength (e.g., as stored in the memory 204 from factory testing or the like).

In particular, the controller 200 may apply the analysis to the magnetic field detected by the Hall sensor 508 to detect a front edge of a printable region of the media segment 124 (e.g., the front edge of the label 528 disposed on the liner 524). Since the Hall sensor 508 and magnet 512 are disposed in the carriage 500 and the detected features are aligned at the printhead 104, upon identifying the front edge using sensor assembly 504 (i.e., the Hall sensor 508 and the magnet 512), the controller 200 may determine that the front edge of the media segment 124 is aligned with the print line 107 of the printhead 104 and may commence the print operation.

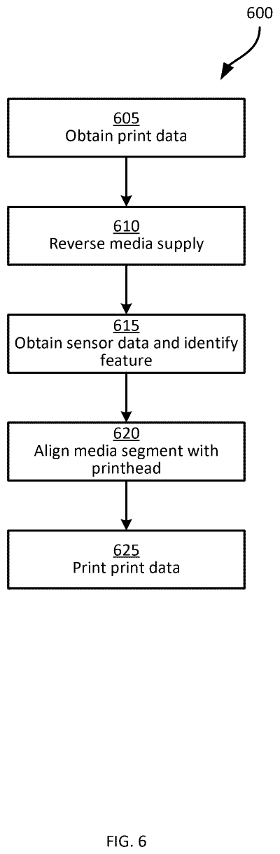

Turning now to FIG. 6, the functionality implemented by the printer 100 will be discussed in greater detail. FIG. 6 illustrates a method 600 of performing a print operation with improved registration alignment accuracy, in accordance with the present disclosure. The method 600 will be discussed in conjunction with its performance in the printer 100. In other examples, the method 600 may be performed by other suitable devices and/or systems.

The method 600 is initiated at block 605, where a print operation is initiated, for example by a computing device or the like in communication (e.g., via a wired or wireless connection) with the printer 100. The print operation may be to print onto one or more of the discrete media segments 124 of the media supply 108. In particular, the controller 200 may obtain the print data for printing on each of the media segments 124 for the print operation.

Optionally, at block 610, the printer 100 may reverse the media supply 108 until a front edge of the media supply 108 is detected by the sensor assembly 212. For example, if the printer 100 employs one of the sensor assemblies 304 or 404, then the controller 200 may control the platen roller 112 and/or the pinch roller 316 to reverse the media supply 108 until the front edge of the media supply 108 is detected by the sensor assembly 304 or 404, i.e., reversed past the print line 107 of the printhead 104. If the printer 100 employs the sensor assembly 504, then the controller 200 may control the platen roller 112 to reverse the media supply 108 until the front edge of the media supply 108 is detected by the sensor assembly 504, i.e., reversed to the print line 107 printhead 104.

In other examples, the printer 100 may be configured for forward feeding the media supply 108 only, and hence may skip block 610.

At block 615, the controller 200 is configured to obtain sensor data from the sensor assembly to identify a feature of the leading media segment 124, such as a front edge of the media segment 124, or the like. In some examples, the controller 200 may control the pinch roller 316 and/or the platen roller 112 to feed the media supply 108 forward until a feature of the leading media segment 124 is identified.

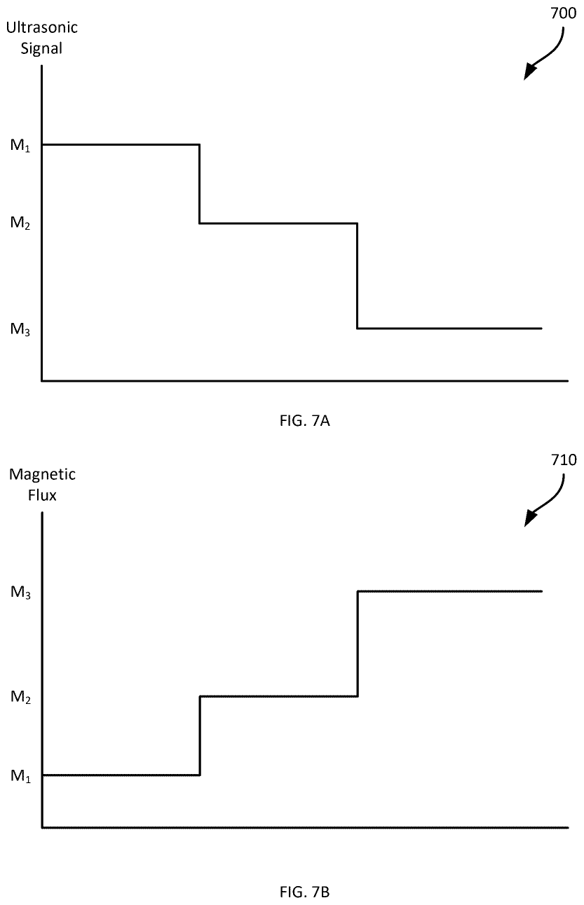

For example, referring to FIG. 7A, an example graph 700 of the ultrasonic signal detected by the ultrasonic receiver 416 is depicted. The receiver 416 may detect a signal of a first magnitude Mi when there is no material between the emitter 412 and the receiver 416 or when only the ribbon 128 is between the emitter 412 and the receiver 416 (for thermal transfer embodiments). The receiver 416 detects a signal of a second magnitude M2 when a liner of the media supply 108 is disposed between the emitter 412 and the receiver 416 or when the liner and the ribbon 128 are between the emitter 412 and the receiver 416 (for thermal transfer embodiments). The receiver 416 detects a signal of a third magnitude M3 when a liner and a media segment (e.g., label) are disposed between the emitter 412 and the receiver 416 or when the liner, the media segment, and the ribbon 128 are between the emitter 412 and the receiver 416 (for thermal transfer embodiments).

The controller 200 may identify a front edge of the label, for example when the signal is within a threshold percentage of the third magnitude M3, when a step (falling edge or rising edge of the signal) of at least a threshold magnitude is detected, combinations of the above, and/or based on another suitable analysis of the detected ultrasonic signal.

Referring to FIG. 7B, an example graph 710 of the magnetic flux signal detected by the Hall sensor 508 is depicted. The Hall sensor 508 may similarly detect a signal of a first magnitude MI when there is no material between the platen roller 112 and the printhead 104 or when only the ribbon 128 is between the platen roller 112 and the printhead 104 (for thermal transfer embodiments). The receiver 416 detects a signal of a second magnitude M2 when a liner of the media supply 108 is disposed between the platen roller 112 and the printhead 104 or when the liner and the ribbon 128 are between the platen roller 112 and the printhead 104 (for thermal transfer embodiments). The receiver 416 detects a signal of a third magnitude M3 when a liner and a media segment (e.g., label) are disposed between the platen roller 112 and the printhead 104 or when the liner, the media segment, and the ribbon 128 are between the platen roller 112 and the printhead 104 (for thermal transfer embodiments).

The controller 200 may identify a front edge of the label, for example when the signal is within a threshold percentage of the third magnitude M3, when a step (falling edge or rising edge of the signal) of at least a threshold magnitude is detected, combinations of the above, and/or based on another suitable analysis of the detected magnetic flux signal.

Returning to FIG. 6, after an identifiable alignment feature, such as a front edge of a label or other printable region of the discrete media segment 124 is detected, the printer 100 proceeds to block 620. At block 620, the controller 200 aligns the media segment 124 with the printhead 104, for example via control of the pinch roller 316 or the platen roller 112, based on the identified feature, and a predefined distance between the sensor assembly 212 and the nip 120. For example, the sensor assembly 504 is aligned with the printhead 104 (e.g., the print line 107 of the printhead 104), and hence the alignment at block 620 may be achieved when the front edge or other alignment feature is detected. In other examples, such as in a printer 100 employing the sensor assemblies 304 or 404, the sensor assembly may be upstream of the printhead 104, and hence the printer 100 may be configured to feed the media supply 108 forward by a specified distance until the media segment 124 is aligned with the printhead 104 (e.g., the print line 107 of the printhead 104). In particular, the printer 100 aligns a printable region of the media segment 124 with the printhead 104 (e.g., the print line 107 of the printhead 104). In some examples, the identified feature may represent an edge of the printable region (e.g., an edge of a label), and hence the printer 100 may align the identified feature with the printhead 104 (e.g., the print line 107 of the printhead 104), while in other examples, the identified feature may be an alignment feature distinct from the printable region, and the printer 100 may determine a location of the printable region based on a predefined spatial relationship of the alignment feature and the printable region within the media segment.

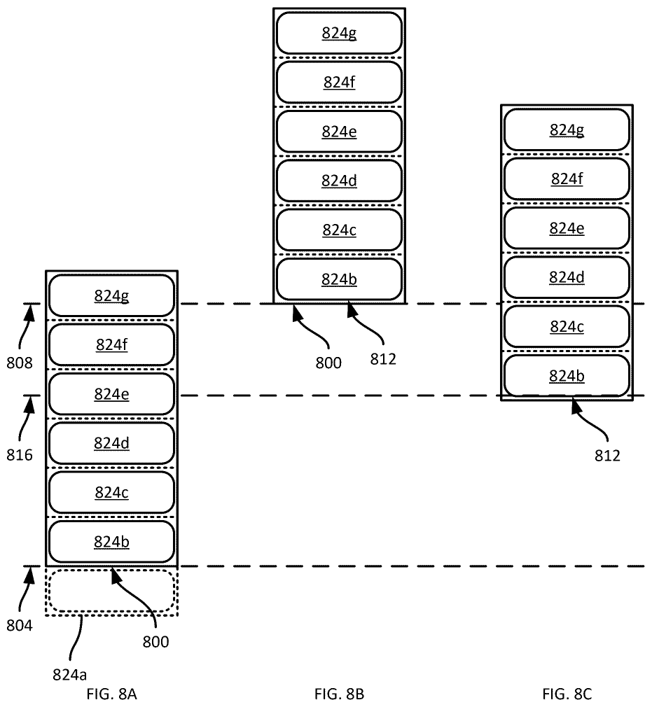

For example, referring to FIG. 8A, the media supply 108 may be positioned with a leading edge 800 at a cut, peel, or tear line 804, for example at or near the outlet 110 of an embodiment of the printer 100. As an example, a printed media segment 824a can be advanced from a print line 816, at which the printhead 104 prints on the printed media segment, and past the line 804 to output the printed media segment 824a from the printer 100. In the present example, the media segments of the media supply 108 have length (measured vertically in the orientation shown in FIGS. 8A-C) that is less than the distance between the print line 816 and the line 804 and is less than the distance between a sensor line 808 and the line 804. As shown in FIG. 8A, to advance the printed media segment 824a past the line 804 and output the printed media segment 824a from the printer 100, the front edges of several nonprinted media segments 824b-e are advanced past the print line, e.g., without the printhead printing on the media segments 824b-e, because the length of the media segments is less than the distance between the print line 816 and the line 804 and/or is less than the distance between a sensor line 808 and the line 804. At block 610, one of the pinch roller 316 or the platen roller 112 may reverse the leading edge 800 of the media supply 108 until at least a front edge 812 of the foremost, next media segment 824b reaches the sensor line 808, as depicted in FIG. 8B, at which the sensor assembly 212 is configured to identify the leading edge 800 and/or the front edge 812 of the foremost media segment 824b (i.e., at block 615). At block 620, after the sensor assembly 212 identifies the leading edge 800 and/or the front edge 812 of the foremost media segment 824b, at least one of the pinch roller 316 or the platen roller 112 advances the media supply 108 until the front edge 812 (i.e., representing a front edge of the printable region) is aligned with a print line 816 (i.e., aligned with the printhead 104), as depicted in FIG. 8C. As described herein, in some instances, a margin can be applied to the media segments. In such instances, the at least one of the pinch roller 316 or the platen roller 112 advances the media supply 108 so that the front edge 812 of the media segment 824b passes the print line 816 by the specified margin.

Returning again to FIG. 6, after aligning the printable region with the printhead 104, at block 625, the printer 100 is configured to print the print data on the media segment 124. If the print operation includes a batch print job for multiple media segments 124, the printer 100 may proceed according to the initial alignment. If the print operation include a separate and independent print job for the next print operation, the printer 100 may iterate through the method 600 for each media segment 124. In some examples, after printing on a predefined number of media segments 124, or other suitable intervals, the printer may iterate through the method 600 for one or more media segments, e.g., to calibrate the printer 100.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A printer comprising:
a printhead supported in a carriage and configured to print onto media segments of a media supply;
a platen roller configured to feed the media supply through a nip defined between the platen roller and the printhead for print operations;
a media guide plate disposed between the media supply and the platen roller, the media guide plate configured to guide the media supply towards the nip;
a sensor assembly supported in at least one of the media guide plate or the carriage, the sensor assembly configured to obtain sensor data representing the media supply; and
a controller configured to:
obtain print data for printing on one media segment of the media segments;
obtain sensor data from the sensor assembly to identify a feature associated with the one media segment; and
align, based on the identified feature, the media segment with the printhead for printing the print data on the one media segment.

2. The printer of claim 1, wherein the sensor assembly comprises a contact image sensor disposed in a recess at an end of the media guide plate proximate the platen roller,
wherein the sensor data comprises image data, and
wherein the controller is configured to apply image analysis to the image data to detect a front edge of the one media segment.

3. The printer of claim 1, wherein the sensor assembly comprises:
an ultrasonic emitter disposed in an aperture at an end of the media guide plate proximate the platen roller; and
an ultrasonic receiver disposed in the carriage opposite the ultrasonic emitter,
wherein the sensor data comprises an ultrasonic signal, and
wherein the controller is configured to identify a change in the ultrasonic signal to detect a front edge of the one media segment.

4. The printer of claim 3, further comprising a ribbon path along which a ribbon travels and the media path along which media travels, and
wherein the ribbon path and the media path are between the ultrasonic emitter and the ultrasonic receiver.

5. The printer of claim 1, wherein the sensor assembly comprises:
a magnet supported in a moveable portion of the carriage; and
a Hall sensor supported in a fixed portion of the carriage and configured to detect a magnetic field of the magnet,
wherein the sensor data comprises the detected magnetic field, and
wherein the controller is configured to identify a change in the detected magnetic field to detect at least one of a front edge or a rear edge of the one media segment.

6. The printer of claim 1, wherein the identified feature comprises at least one of a front edge or a rear edge of the one media segment, and wherein the controller is configured to align a printable region of the one media segment with the printhead based on the identified feature.

7. The printer of claim 1, wherein the identified feature comprises an alignment feature distinct from front and rear edges of the one media segment, and wherein the controller is configured to align a printable region of the one media segment with the printhead based on a predefined spatial relationship of the alignment feature and at least one of the front edge or the rear edge of the one media segment.

8. The printer of claim 1, further comprising a pinch roller configured to reverse the media supply to allow at least one of a leading edge or a rear edge of the one media segment of the media supply to be detected by the sensor assembly.

9. The printer of claim 1, wherein a sensing area of the sensor assembly is positioned at a distance of between five millimeters and twenty millimeters away from a print line of the printhead or the sensing area of the sensor assembly is aligned with the print line.

10. The printer of claim 1, wherein a sensing area of the sensor assembly is positioned at a distance away from a print line of the printhead, wherein the distance is between one and three times the radius of the platen roller.

11. The printer of claim 1, further comprising:
an outlet through which the media segments are output,
wherein a length of the media segments is less than a distance between the sensor assembly and an outlet and the feature is a front edge of the media segment,
wherein, after a printed media segment is removed from the media supply, the controller is configured to reverse the media supply until the front edge of the one media segment is identified by the sensor assembly, and
wherein the controller aligns a printable region of the one media segment with a print line of the printhead for printing the print data on the one media segment based on the identified front edge.

12. A method of printing in a printer, the method comprising:
obtaining print data for printing on a media segment of a plurality of media segments forming a media supply;
obtaining sensor data from a sensor assembly supported in at least one of a media guide plate or a carriage of a printhead of the printer;
identifying, using the sensor data, a feature associated with the media segment;
aligning, based on the identified feature, the media segment with the printhead; and
printing the print data onto the media segment.

13. The method of claim 12, wherein the sensor assembly comprises a contact image sensor disposed in a recess at an end of the media guide plate proximate a platen roller;
wherein the sensor data comprises image data, and wherein identifying the feature of the media segment comprises applying image analysis to the image data to detect a front edge of the media segment.

14. The method of claim 12, wherein the sensor assembly comprises:
an ultrasonic emitter disposed in an aperture at an end of the media guide plate proximate a platen roller; and
an ultrasonic receiver disposed in the carriage opposite the ultrasonic emitter,
wherein the sensor data comprises an ultrasonic signal, and wherein identifying the feature of the media segment comprises identifying a change in the ultrasonic signal to detect a front edge of the media segment.

15. The method of claim 12, wherein the sensor assembly comprises:
a magnet supported in a moveable portion of the carriage; and
a Hall sensor supported in a fixed portion of the carriage and configured to detect a magnetic field of the magnet,
wherein the sensor data comprises the detected magnetic field, and wherein identifying the feature of the media segment comprises identifying a change in the detected magnetic field to detect at least one of a front edge or a rear edge of the media segment.

16. The method of claim 12, comprising:
identifying at least one of a front edge or a rear edge of a printable region of the one media segment; and
aligning the front edge of a printable region of the one media segment with the printhead based on identifying the at least one of a front edge or a rear edge.

17. The method of claim 12, comprising:
identifying an alignment feature distinct from a front edge and a rear edge of the printable region of the one media segment; and
aligning the printable region of the one media segment with the printhead based on a predefined spatial relationship of the alignment feature and the front edge or the rear edge of the printable region of the one media segment.

18. The method of claim 12, further comprising:
reversing, using a pinch roller, the media supply; and
detecting, using the sensor assembly, at least one of a leading edge or a rear edge of the media supply.

19. The method of claim 12, wherein a sensing area of the sensor assembly is positioned at a distance away from a print line of the printhead, wherein the distance is between one and three times the radius of the platen roller.

20. The method of claim 12, further comprising:
outputting at least some of the media segments through an outlet, wherein a length of the media segments is less than a distance between the sensor assembly and an outlet and the feature is a front edge of the media segment;
after a printed media segment is removed from the media supply, reversing the media supply until the front edge of the one media segment is identified by the sensor assembly; and
aligning a printable region of the one media segment with a print line of the printhead for printing the print data on the one media segment based on the identified front edge.
